(19) United States
(12) Patent Application Publication
(10) Pub. No.: US 2013/0223195 A1
(43) Pub. Date: Aug. 29, 2013

(54) WRISTWATCH PROVIDED WITH A CLASP

(71) Applicant: CK Montres & Bijoux Co., SA, (US)

(72) Inventor: Philippe LOETSCHER, Evilard (CH)

(73) Assignee: CK Montres & Bijoux Co., SA, Bienne (CH)

(21) Appl. No.: 13/771,667

(22) Filed: Feb. 20, 2013

(30) Foreign Application Priority Data
Feb. 23, 2012 (EP) 12156671.5

(51) Int. Cl. G04B 37/00

(52) U.S. Cl. CPC G04B 37/0008
USPC 368/282

(57) ABSTRACT

The wristwatch (2) includes a clasp (12), formed of a lever (14) connected to a connecting pin (16) mounted on a portion integral with the case (4) so as to rotate about a first axis of rotation (24). A buckle (18) is mounted on the connecting pin so as to be rotatable about a second axis of rotation at a distance from the first axis. A hook (20), in which the buckle is placed, is arranged at the end of the bracelet (8) for closing the clasp by actuating the lever. In a preferred embodiment, the bracelet is arranged to exert a traction force on the hook when the lever is in the closed position thereof. In a preferred variant, the first and second axes of rotation are arranged so that the clasp forms a mechanical toggle type mechanism.

This application claims priority from European Patent Application No. 12156671.5 filed Feb. 23, 2012 the entire disclosure of which is incorporated herein by reference.

### FIELD OF THE INVENTION

The present invention concerns the field of external watch components and in particular the field of clasps associated with watch bracelets.

### BACKGROUND OF THE INVENTION

Numerous wristwatches have been proposed with different types of clasp. A clasp for a flexible bracelet or strap, formed of a buckle and tongue passing through a bracelet strand via one hole among a plurality of holes provided for this purpose, is well known. Clasps with a deployant buckle are used in particular for bracelets formed of metal or ceramic links. Other types of clasp have also been proposed, for example, devices with side push-buttons or devices with a latch/cover assembled to one bracelet strand imprisoning a fastening element assembled to the other bracelet strand. The cover is, for example, closed by a snap or pressure fastening system, or by a push-button system.

### SUMMARY OF THE INVENTION

It is an object of the present invention to provide a new clasp which is easy to handle and simple to construct. According to a particular object of the invention, the clasp is arranged to be actuated on the side of the watch case and contributes to the attractive appearance of the watch case.

The present invention therefore generally concerns a watch comprising a case for a timepiece movement, a bracelet and a clasp. The clasp includes a lever, a connecting pin integral with the lever and defining a first axis of rotation about which said connecting pin and said lever are rotatable, a first fastening element mounted on the connecting pin so as to be rotatable about a second axis of rotation at a distance from the first axis of rotation, and a second fastening element cooperating with the first fastening element to close or open the clasp according to whether the lever is respectively in a closed position, in which the first and second fastening elements are assembled, or in an open position in which said first and second fastener elements can easily be or are separated from each other. The clasp is arranged so that the first fastening element undergoes a rotation, at least initially, about a third axis of rotation, when the lever is actuated from the closed position to the open position thereof, the second axis of rotation being positioned relative to the first axis of rotation so that, when the lever is actuated from the closed position to the open position thereof, said second axis of rotation undergoes a movement, the result of which, projected into a geometrical plane comprising the first axis of rotation and the third axis of rotation, has a component which is not zero and is directed towards the third axis of rotation. The second axis of rotation undergoes a reverse movement when the lever is actuated from the open position to the closed position thereof.

According to a preferred embodiment, the clasp forms a mechanical toggle type mechanism, the connecting pin being arranged so that the second axis of rotation is located underneath the aforementioned geometrical plane, relative to the interior of the bracelet, when the lever is in the closed position thereof, and so that the second axis of rotation passes above said geometrical plane when the lever is actuated from the closed position to the open position thereof.

According to a preferred variant, the bracelet is formed and connected to the watch case so as to exert, without however tightening around the user's wrist, a certain traction force on the second fastening element and/or on the first fastening element when the clasp is closed, said traction force assembling the first and second fastening elements to each other when the lever is in the closed position.

According to a particular embodiment, the clasp is arranged at one end of the bracelet on the side of the watch case, the second fastening element being connected to a rigid portion integral with the case or the connecting pin being mounted on a rigid portion integral with said case so as to be rotatable about the first axis of rotation.

According to a variant, the lever extends above the watch case in the closed position thereof, said lever having at least one aperture for at least partially revealing the watch display.

Other particular features of the invention will be set out below in the

### DETAILED DESCRIPTION OF THE INVENTION

### BRIEF DESCRIPTION OF THE DRAWINGS

The invention will be described below with reference to the annexed drawings, given by way of non-limiting example, and in which:

FIG. 1 is a perspective view of a wristwatch according to a first preferred embodiment of the invention.

FIG. 2 is a perspective view from the side of the wristwatch of FIG. 1 with the clasp open.

FIG. 3 is a partial perspective view from the top of the wristwatch of FIG. 1 with the clasp open.

FIG. 4 is a side view of the wristwatch of FIG. 1 with the clasp closed.

FIG. 5 is an explanatory diagram of the arrangement and operation of the mechanical toggle typemechanism clasp according to a preferred variant of the invention.

FIG. 6 is a partial cross-section showing a system for securing the lever to the watch case in the closed position thereof.

FIG. 7 is a side view of a first embodiment of a wristwatch provided with a clasp according to the invention in the closed position thereof.

FIG. 8 is a similar view to that of FIG. 7, with the clasp in an open position.

FIG. 9 is a partial cross-section of the wristwatch of FIG. 7 through the middle of the bracelet and clasp.

### DETAILED DESCRIPTION OF THE INVENTION

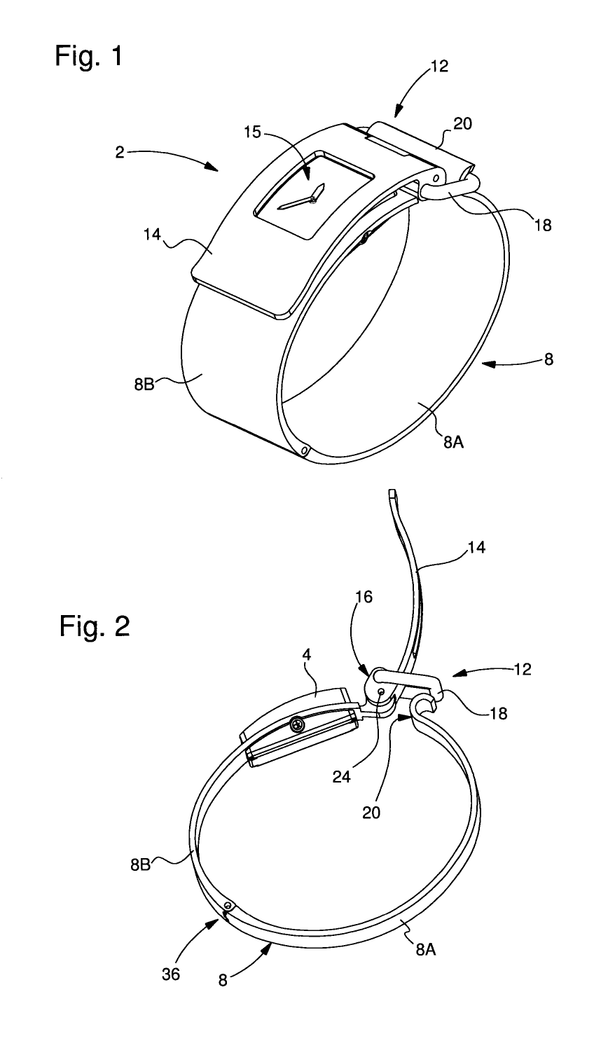

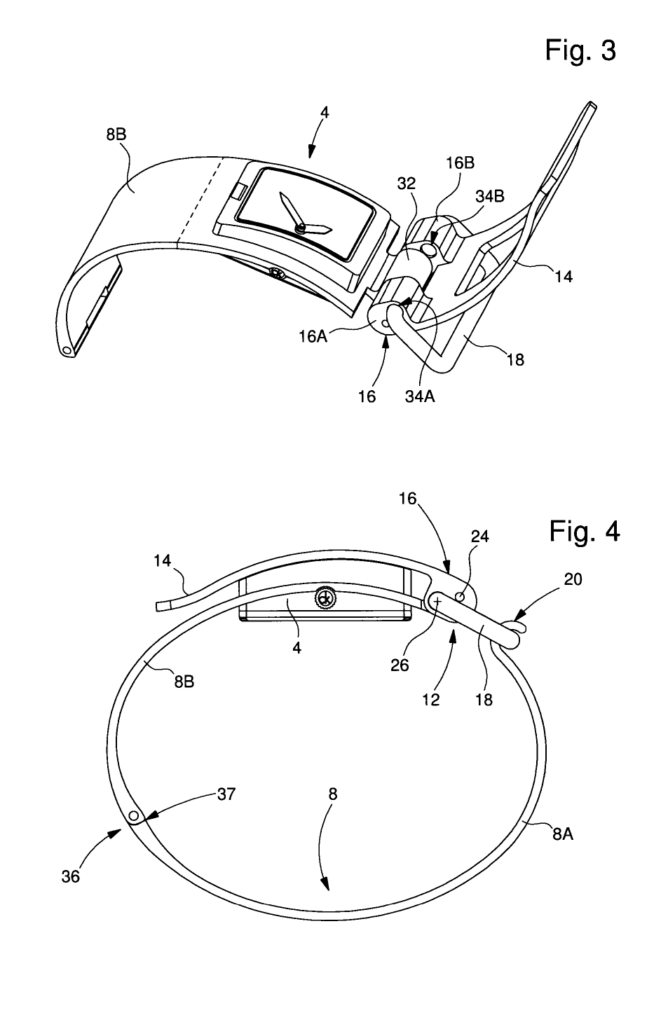

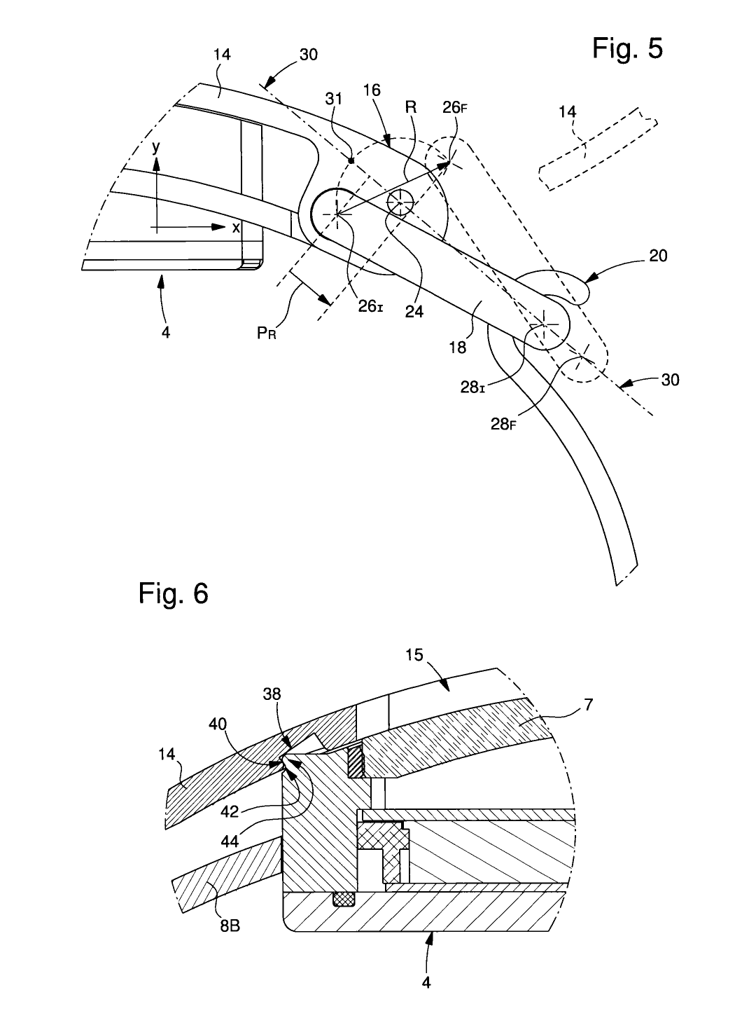

A wristwatch 2 according to a first preferred embodiment of the invention will be described with reference to FIGS. 1 to 6. This wristwatch includes a case 4 for a timepiece movement, a bracelet 8 formed of two portions 8A and 8B made of rigid material with a certain amount of flexibility, and a clasp 12 associated with the bracelet. Clasp 12 is arranged at one end of said bracelet 8 on the side of case 4. It includes a lever 14, a connecting pin 16 integral with the lever and having a first axis of rotation 24 about which said connecting pin and said lever are rotatable. The clasp further includes a first fastening element 18, mounted on the connecting pin so as to be rotatable about a second axis of rotation 26 at a distance from the first axis of rotation, and a second fastening element 20 cooperating with the first fastening element to close and open the clasp according to whether the lever is respectively in a closed position (FIG. 1), in which the first and second fastening elements are assembled to each other, and in an open position (FIG. 2) in which said first and second fastening elements can be separated from each other. It will be noted that the second axis of rotation 26 undergoes a rotational motion about the first axis 24 when the lever is actuated. In a reference system connected to first axis 24 and to case 4, where said first axis is fixed with respect to the case since connecting pin 16 is mounted here on a portion 32 rigidly connected to said case, the second axis thus passes from an initial position 26₁ to a final position 26_{F} as indicated in FIG. 5.

In the variant shown in the annexed Figures, the first fastening element is formed by buckle 18. This buckle is of generally rectangular shape and is open on the side of the connecting pin 16. The two end portions of said buckle are respectively inserted into two collinear circular holes 34A and 34B which define the second axis of rotation 26, said two circular holes being respectively provided in two similar distinct elements 16A and 16B forming connecting pin 16 and connected to each other by the base of lever 14. Portion 32, integral with case 4, is inserted between the two elements 16A and 16B. In another variant, there may be a reverse configuration with two integral portions of the case arranged in place of the two elements 16A and 16B and each having a hole for the first axis 24, whereas the connecting pin formed by a single element is arranged between the two fixed portions in place of portion 32. Other variants may be envisaged by those skilled in the art. Thus, for example, buckle 18 may be replaced by a generally T-shaped element and the hook is then machined in the median portion thereof to obtain two claws, which respectively retain the two half-bars defining the top cross-bar of the T, with the vertical bar of the T passing between the two claws.

In the variant shown in the annexed Figures, the second fastening element is formed by a hook 20. In these Figures, the hook forms one end of a rigid bracelet. This hook may be formed in other variants by a distinct element assembled to bracelet 8. In FIGS. 1 to 4, portion 8B of the bracelet continues with a portion surrounding case 4 which ends in portion 32 on which connecting pin 16 is mounted. Here too, other variants may be envisaged. In particular, portion 32 may be secured directly to the case or be integral with at least one portion of said case.

In the particular variant of the first embodiment shown in FIGS. 1 to 6, lever 14 is folded down on the side of the watch case in the closed position thereof. Preferably, the lever extends above the watch case in the closed position thereof and has at least one aperture 15 to at least partially reveal the watch display underneath crystal 7 of case 4. In a variant, case 4 is arranged to penetrate or pass through aperture 15 of the lever when the lever is closed. It will be noted that, in another embodiment, the hook is integral with the case and the unit formed of the connecting pin, the lever and the buckle is integral with portion 8A of the bracelet.

According to the invention, as shown schematically in FIG. 5, buckle 18 undergoes a rotation, at least initially, about a third axis of rotation 28₁ when lever 14 is actuated from the closed position to the open position thereof. The second axis of rotation 26 is positioned relative to first axis of rotation 24 so that, when the lever is actuated from the closed position to the open position thereof, this second axis of rotation undergoes a motion, the resultant R of which, projected into a geometrical plane 30 comprising said first axis of rotation and said third axis of rotation, has a component P_{R} which is not zero and is directed towards the third axis of rotation 28₁. This second axis of rotation undergoes a reverse movement when the lever is actuated from the open position to the closed position thereof. Owing to these features, buckle 18 pulls on hook 20 when the clasp is closed and therefore reduces the length of the bracelet relative to the open position of the lever. This generates or increases tension on the bracelet, in particular when the length thereof is adjusted around the wrist of the user of wristwatch 2 in the open position of the lever with the buckle inserted in the hook. It will be noted that, when the lever is actuated, buckle 18 undergoes a complex motion which can be broken down into a rotation and a translation. Thus, in a reference system connected to case 4 and to the first axis of rotation 24, the third axis of rotation is moved between an initial position 28₁ and a final position 28_{F} shown approximately in FIG. 5, said final position depending on various parameters and particularly on a traction force exerted by the hook as indicated below and on the movement of said hook when the clasp is opened.

In a preferred variant shown in FIGS. 1 to 5, bracelet 8 is arranged so that the two rigid but flexible portions 8A and 8B thereof abut against each other on a hinge 36 in a configuration shown in FIG. 2, where the hook is at a certain distance from the first axis of rotation which is greater than the distance between said hook and said first axis when the clasp is closed. Generally, in this particular variant, the bracelet is formed and connected to said case so as to exert, without however tightening around the user's wrist, a certain traction force on the second fastening element and/or on the first fastening element when the clasp is closed, with said traction force assembling the first and second fastening elements to each other when said lever is in the closed position thereof.

According to another preferred variant of the invention shown in the annexed Figures, clasp 12 forms a mechanical toggle type mechanismclasp, connecting pin 16 being arranged so that the second axis of rotation 26 is located underneath geometrical plane 30, relative to the interior of the bracelet, when lever 14 is in the closed position thereof (second axis 26₁) and so that said second axis of rotation passes above said geometrical plane 30 when the lever is actuated from the closed position to the open position (second axis 26_{F}) as shown schematically in FIG. 5. Thus, when lever 14 is actuated between the closed position and open position thereof, the hook is first of all moved closer to the connecting pin and more particularly to first axis 24 before finally being moved away by a greater distance to allow clasp 12 to be opened. When there is a traction force on the hook when the clasp is closed, as in the variant described above, this traction force and thus the tension in at least portion 8A of the bracelet increases in an initial phase until the lever reaches a position 31 corresponding to a maximum traction force, which substantially corresponds to the situation where the second axis 26 is in geometrical plane 30 (and precisely when the three axes are aligned). Next, the traction force decreases and, depending on the arrangement of the bracelet, may even become zero in a final phase where the lever moves closer to its open position. The toggle type mechanism clasp thus has a sort of “hard point” on the travel of the lever. This has a very advantageous effect since the lever is held in its closed position without having to be locked.

Although, when there is tension in the bracelet, the toggle type mechanism system allows the clasp to be held in the closed configuration, with a variant shown in FIG. 6 the closed position of the lever is ensured. To achieve this, a first locking element 40 is provided on lever 14, cooperating with a second complementary locking element 44, arranged on a portion of the case opposite or against which the lever is placed when the clasp is closed. In the particular case shown, the locking system is a snap system in which a beak 40 formed on a lateral wall of a recess 38 is snapped into a hollow 42 passing above a flange 44 formed by said hollow. The lever can then be released when actuated by a user to open the clasp. Other locking systems may be provided by those skilled in the art.

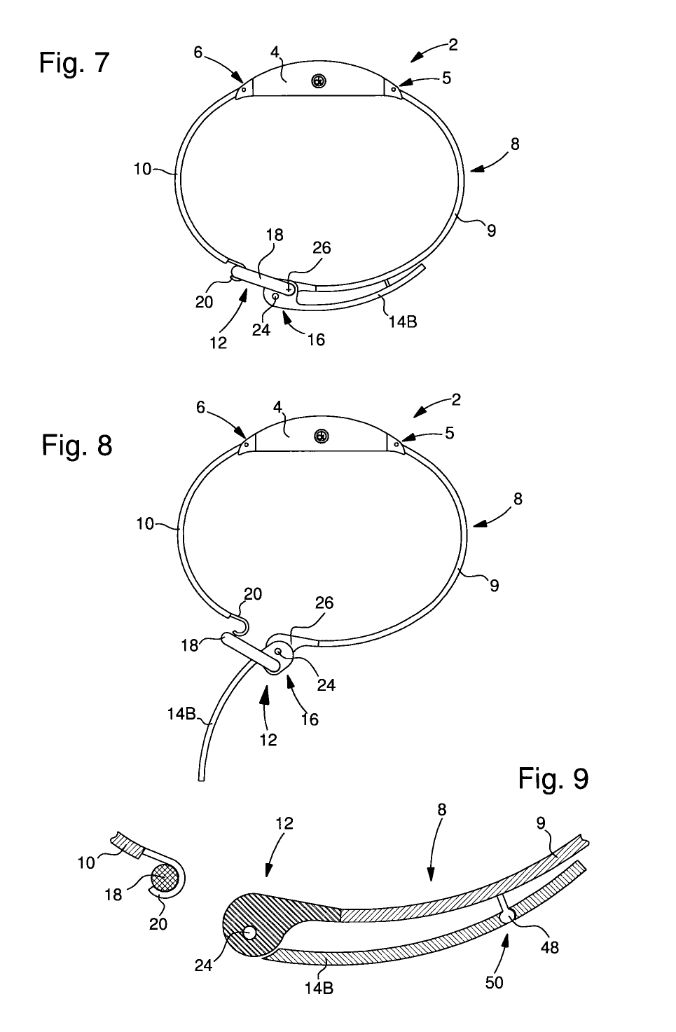

FIGS. 7 to 9 show a second embodiment of a wristwatch according to the invention. This second embodiment essentially differs from the first embodiment in the position of the clasp, which is located, in a conventional manner, substantially opposite case 4, i.e. on the bottom side of the user's wrist. Clasp 12 is similar to that described previously and will not be described again here in detail. It will be noted that lever 14B does not have an aperture.

Bracelet 8 is formed of two strands 9 and 10 each having a first end assembled to watch case 4 by a fastening device respectively 5 and 6. Preferably, the two bracelet strands are formed of a rigid material which has some flexibility. They may be for example made of metal or synthetic material such as hard plastic. In order to generate a traction force on the clasp in the closed configuration thereof, the ends of the bracelet abut against portions of said case respectively on two devices in a configuration where the second fastening element 20 is at a greater distance from said first axis of rotation 24 than the distance between said element 20 and said axis 24 when the clasp is closed.

In a particular variant shown in FIG. 9, the closed position of lever 14B is ensured or maintained by a push-button type locking system. A substantially ball-shaped button 48 is fixed to bracelet strand 9 and snapped into a hole 50 made in lever 14B. This hole has a concave lateral wall. Other embodiments for locking lever 14B into the closed position may be provided by those skilled in the art. It will be noted that the portion of the bracelet on which connecting pin 16 is mounted forms a distinct element of strand 9 which is fixed to one end of said bracelet strand. Likewise, hook 20 is formed by a distinct element of strand 10 and is secured to the end of said strand 10. Finally, it will be noted that in this variant, it is possible for the bracelet strands to be flexible, for example made of leather, since the lever is held in the closed position by the locking system. The traction force required for the particular effect of a mechanical toggle type mechanism is thus no longer necessary. However, if the length of the bracelet is adjusted to the user's wrist, a certain tension may appear when the clasp is closed and generate a certain traction force on hook 20 due to tightening on the wrist.

What is claimed is:

1. A watch including a case for a timepiece movement, a bracelet and a clasp, wherein the clasp includes a lever, a connecting pin integral with the lever and defining a first axis of rotation about which said connecting pin and said lever are rotatable, a first fastening element, mounted on the connecting pin so as to be rotatable about a second axis of rotation at a distance from the first axis of rotation, and a second fastening element cooperating with said first fastening element in order to close and open the clasp according to whether the lever is respectively in a closed position, in which the first and second fastening elements are assembled to each other, or in an open position, in which said first and second fastening elements can be or are separated from each other, and wherein said first fastening element undergoes a rotation, at least initially, about a third axis of rotation when said lever is actuated from the closed position to the open position thereof, said second axis of rotation being positioned relative to said first axis of rotation so that, when the lever is actuated from the closed position to the open position thereof, said second axis of rotation undergoes a motion, the resultant of which, projected into a geometrical plane including said first axis of rotation and said third axis of rotation, has a component which is not zero and is directed towards said third axis of rotation, and wherein said second axis of rotation undergoes a reverse motion when the lever is actuated from the open position to the closed position thereof.

2. The watch according to claim 1, wherein said lever of said clasp includes a first locking element cooperating with a second complementary locking element, arranged on a portion of the watch facing or against which the lever is placed when the clasp is closed, to ensure the closed position of the lever, said lever being able to be released when actuated by a user to open the clasp.

3. The watch according to claim 1, wherein said first fastening element is formed by a buckle.

4. The watch according to claim 1, wherein said second fastening element is formed by a hook.

5. The watch according to claim 1, wherein said clasp forms a mechanical toggle type mechanism clasp, said connecting pin being arranged so that said second axis of rotation is located underneath said geometrical plane, relative to the interior of the bracelet, when said lever is in the closed position thereof, and so that said second axis of rotation passes above said geometrical plane when the lever is actuated from the closed position to the open position thereof.

6. The watch according to claim 5, wherein said bracelet is formed and connected to said case so as to exert, without however tightening around the wrist of a user, a certain traction force on said second fastening element and/or on said first fastening element when said clasp is closed, said traction force assembling the first and second fastening elements to each other when said lever is in the closed position thereof.

7. The watch according to claim 6, wherein said bracelet is formed by a rigid material having some flexibility, said bracelet being arranged so that two of the portions thereof abut against each other at a hinge or so that the ends of the bracelet abut against portions of said case when said bracelet is in a configuration in which said second fastening element is at a greater distance from said first axis of rotation than the distance between said first axis of rotation and said second fastening element when the clasp is closed.

8. The watch according to claim 1, wherein said clasp is arranged at one end of said bracelet on the side of said case, said second fastening element being connected to a rigid portion integral with said case or said connecting pin being mounted on a rigid portion integral with said case so as to be rotatable about said first axis of rotation.

9. The watch according to claim 8, wherein said lever is folded down on the side of the watch case in the closed position thereof.

10. The watch according to claim 9, wherein said lever extends above the watch case in the closed position thereof, said lever having at least one aperture for at least partially revealing the watch display.
